(19) United States
(12) Patent Application Publication
(10) Pub. No.: US 2014/0146566 A1
(43) Pub. Date: May 29, 2014

(54) Backlight Module

(71) Applicant: TPV Display Technology (Xiamen) Co., Ltd., Xiamen (CN)

(72) Inventors: Junyi Zheng, Xiamen (CN); Po-Iem Lin, Xiamen (CN); Wei Lin, Xiamen (CN)

(73) Assignee: TPV Display Technology (Xiamen) Co., Ltd., Xiamen (CN)

(21) Appl. No.: 14/091,418

(22) Filed: Nov. 27, 2013

(30) Foreign Application Priority Data
Nov. 29, 2012 (CN) 201210501684.4

(51) Int. Cl. F21V 8/00

(52) U.S. Cl. CPC G02B 6/0023; G02B 6/0025; G02B 6/0026
USPC 362/608

(57) ABSTRACT

A backlight module including a light source, a light guide plate, and a light-transmitting structure is provided. The light source includes LEDs each having a light exit surface. The light guide plate has a light incident surface and a light exit surface perpendicular to the light incident surface. The light-transmitting structure has a light incident surface and a light exit surface opposite to the light incident surface, and is disposed to fill a gap between the light exit surfaces of the light source and the light incident surface of the light guide plate. The light exit surfaces of the light source are connected to the light incident surface of the light-transmitting structure; the light exit surface of the light-transmitting structure is connected to the light incident surface of the light guide plate; the light exit surface of the light guide plate outputs diffused light. The invention may realize narrower bezel design, reduce the number of the LEDs, and enhance light incident coupling efficiency between the light source and the light guide plate.

### BACKGROUND OF THE INVENTION

1. Field of the Invention

The invention relates to a backlight module. More particularly, the invention relates to an edge-lit backlight module.

2. Description of the Related Art

In the prior art, in a backlight module, whether or not there exists other medium between light exit surfaces of light-emitting diodes (LEDs) and a light incident surface of a light guide plate, there still exists an air gap between the light exit surfaces of the LEDs and the light incident surface of the light guide plate; therefore, light emitted by the LEDs needs to pass through air before being incident on the light guide plate. As shown in FIG. 1, assuming that air has a refractive index n1 of 1, and the light guide plate 2 has a refractive index n2 of 1.49, Snell's law states that, when light travels from a medium with a lower refractive index to one with a higher refractive index, the angle of refraction θ2 is less than the angle of incidence θ1, and the relation can be expressed as a formula: n1×sin θ1=n2×sin θ2; therefore, even if the angle of incidence θ1 is up to 90°, the angle of refraction θ2 is only 42°. As a result, as shown in FIG. 2, in a conventional edge-lit backlight module, when light emitted by each of the LEDs of the light source 1 travels from air into the light guide plate 2, the angle of entrance of the light at the light incident side of the light guide plate is 2×θ2 less than 84°, and a distance D1 required to achieve uniform light mixing in the light guide plate 2 is relatively long accordingly; moreover, there exists a triangle dark region S1, called a hot spot, between two adjacent LEDs of the light source 1, resulting that a bezel in which the backlight module is disposed needs to have a width larger than the distance D1. As backlighting technology develops, the design of backlight module tends to narrow the bezel and reduce the number of the LEDs, and there is a need to overcome or improve the hot spot problem at the light incident side of the light guide plate.

### SUMMARY OF THE INVENTION

The invention is adapted to providing a backlight module to enhance light mixing of the light source and improve the hot spot problem at the light incident side of the light guide plate.

According to an aspect of the invention, there is provided a backlight module including a light source, a light guide plate, and a light-transmitting structure. The light source includes LEDs; each of the LEDs has a light exit surface. The light guide plate is made of transparent material; the light guide plate has a light incident surface and a light exit surface perpendicular to the light incident surface. The light-transmitting structure is made of transparent material; the light-transmitting structure has a light incident surface and a light exit surface opposite to the light incident surface; the light-transmitting structure is disposed between the light exit surfaces of the light source and the light incident surface of the light guide plate, and fills a gap between the light exit surfaces of the light source and the light incident surface of the light guide plate. Moreover, the light exit surfaces of the light source are connected to the light incident surface of the light-transmitting structure; the light exit surface of the light-transmitting structure is connected to the light incident surface of the light guide plate; light emitted by the light source is diffused by the light guide plate to output through the light exit surface of the light guide plate.

According to another aspect of the invention, the light-transmitting structure may have a refractive index between 1.0 and 2.0. Preferably, the refractive index of the light-transmitting structure is between 1.4 and 1.6.

According to another aspect of the invention, the light-transmitting structure may have a refractive index the same as that of the light guide plate.

According to another aspect of the invention, the light-transmitting structure may be an elastic structure or a viscous structure. When the light-transmitting structure is an elastic structure or a viscous structure, the light-transmitting structure may be made of resin, acrylic, or silicone.

According to another aspect of the invention, the light-transmitting structure may consist of at least one sheet-like structure made of transparent material.

According to another aspect of the invention, the light-transmitting structure may be doped with diffuser particles, bubbles, or phosphor powders. The diffuser particles may have a mean diameter between 0.1 μm and 100 μm. The diffuser particles may be made of Al₂O₃, B₂O₃, BaCO₃, Bi₂O₃, CaCO₃, CeO₂, Cr₂O₃, CoO, CO₃O₄, CuO, Dy₂O₃, Er₂O₃, Eu₂O₃, Fe₂O₃, Ga₂O₃, Ge₂O₃, Gd₂O₃, HfO₂, Ho₂O₃, In₂O₃, K₂O₃, Li₂CO₃, MgO, Mn₂O₃, Nb₂O₅, Nd₂O₃, NiO, PbO, SiO₂, Sm₂O₃, SnO₂, Ta₂O₅, Tb₄O₇, TiO₂, WO₃, Y₂O₃, ZnO, or ZrO₂.

According to another aspect of the invention, the light-transmitting structure may be in a liquid state, a gel state, or a solid state.

According to another aspect of the invention, the light-transmitting structure may be made of polyethylene terephthalate glycol-modified (PETG), polypropylene (PP), polytetrafluoroethylene (PTFE), polyvinyl chloride (PVC), polystyrene (PS), polyethylene terephthalate (PET), Poly(methyl methacrylate) (PMMA), polycarbonate (PC), polyamide (PA), polyimide (PI), or silicone. In the invention, the light-transmitting structure is used to fill the air gap between the light source and the light guide plate; therefore, instead of passing through air, light emitted by the light source is directly incident on the light-transmitting structure and then incident on the light guide plate so as to be output through the light exit surface of the light guide plate. The light-transmitting structure has a refractive index the same or similar as that of the light guide plate to reduce or eliminate the difference of refractive indices to keep the original angle of incidence of the light source to enhance light mixing of the light source and reduce the distance required to achieve uniform light mixing in the light guide plate accordingly; therefore, the invention may realize narrower bezel design, and may still achieve uniform light mixing even if the number of the LEDs decreases under the condition of constant light-mixing distance; that is, it may enhance light incident coupling efficiency between the light source and the light guide plate. In addition, the light-transmitting structure may be doped with diffuser particles or bubbles to make light distribution more uniform, or may be doped with phosphor powders to make light emitted by the light source have variable color according to the kind of the phosphor powders when passing through the light-transmitting structure.

### BRIEF DESCRIPTION OF THE DRAWINGS

The invention will be described in further detail below under reference to the accompanying drawings, in which:

FIG. 1 is an optic path diagram of a backlight module;

FIG. 2 is a schematic structural diagram of a conventional backlight module;

FIG. 3 is a schematic structural diagram of a backlight module according a first embodiment of the invention, illustrating that light-transmitting structures correspond to light exit surfaces of LEDs, respectively;

FIG. 4 is an enlarged cross-sectional view along the line A-A of FIG. 3;

FIG. 5 is a schematic structural diagram of a backlight module according a second embodiment of the invention, illustrating that a light-transmitting structure corresponds to a light incident surface of a light guide plate;

FIG. 6 is a schematic structural diagram of a backlight module according a third embodiment of the invention, illustrating that light-transmitting structures each consisting of sheet-like structures correspond to light exit surfaces of LEDs, respectively;

FIG. 7 is a schematic structural diagram of a backlight module according a fourth embodiment of the invention, illustrating that a light-transmitting structure consisting of sheet-like structures corresponds to a light incident surface of a light guide plate;

FIG. 8 is a schematic structural diagram of a backlight module according a fifth embodiment of the invention, illustrating that a light-transmitting structure is doped with a material;

FIG. 9 is a schematic light-mixing diagram of a backlight module according an embodiment of the invention using the same number of LEDs, compared to the conventional backlight module as shown in FIG. 2; and

FIG. 10 is a schematic light-mixing diagram of a backlight module according an embodiment of the invention having the same light-mixing distance, compared to the conventional backlight module as shown in FIG. 2.

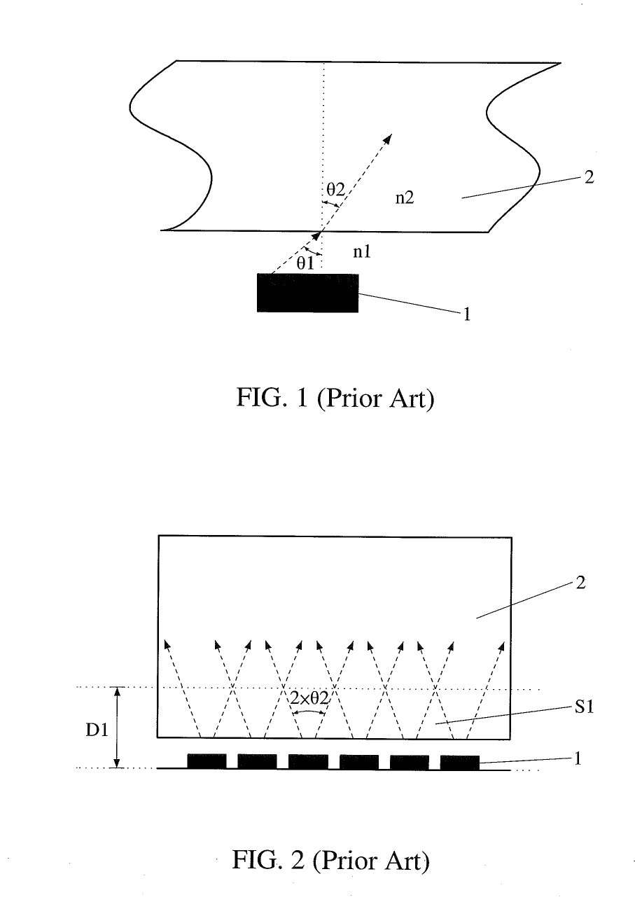

### DETAILED DESCRIPTION OF THE INVENTION

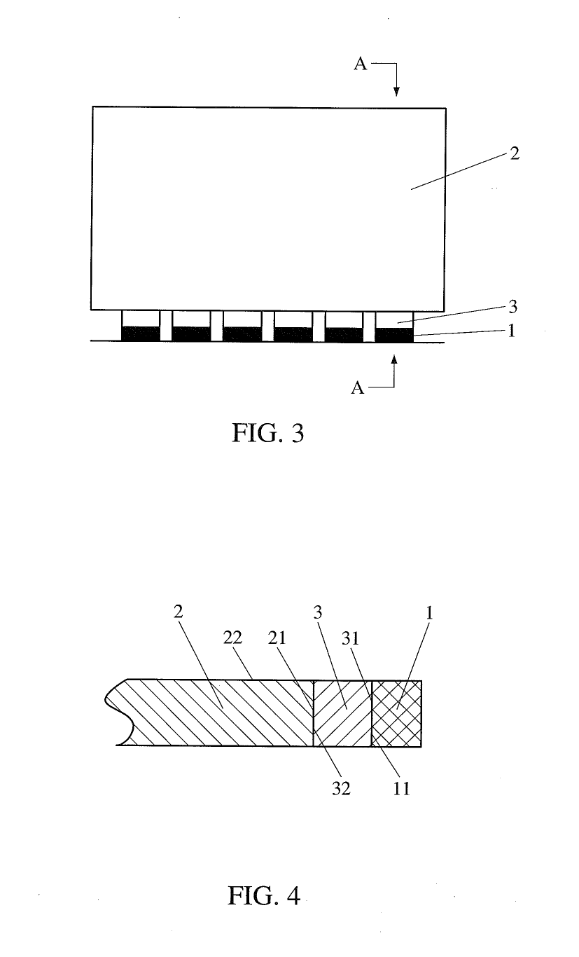

FIG. 3 is a schematic structural diagram of a backlight module according a first embodiment of the invention, and FIG. 4 is an enlarged cross-sectional view along the line A-A of FIG. 3. As shown in FIGS. 3 and 4, in the first embodiment, the backlight module includes a light source 1, a light guide plate 2, and light-transmitting structures 3. The light source 1 includes LEDs; each of the LEDs has a light exit surface 11. The light guide plate 2 is made of transparent material; the light guide plate 2 has a light incident surface 21 and a light exit surface 22 perpendicular to the light incident surface 21. The light-transmitting structures 3 are made of transparent material; each of the light-transmitting structures 3 has a light incident surface 31 and a light exit surface 32 opposite to the light incident surface 31; the light-transmitting structures 3 are disposed between the light exit surfaces 11 of the light source 1 and the light incident surface 21 of the light guide plate 2, and fill a gap between the light exit surfaces 11 of the light source 1 and the light incident surface 21 of the light guide plate 2. It is noted that the light-transmitting structures 3 correspond to the light exit surfaces 11 of the light source 1, respectively; that is, the light exit surface 11 of each of the LEDs of the light source 1 has a corresponding light-transmitting structure 3 disposed thereon. For one LED of the light source 1, the light guide plate 2, and one light-transmitting structure 3, as shown in FIG. 4, the light exit surface 11 of the LED of the light source 1 is connected to the light incident surface 31 of the light-transmitting structure 3; the light exit surface 32 of the light-transmitting structure 3 is connected to the light incident surface 21 of the light guide plate 2; light emitted by the light source 1 is diffused by the light guide plate 2 to output through the light exit surface 22 of the light guide plate 2.

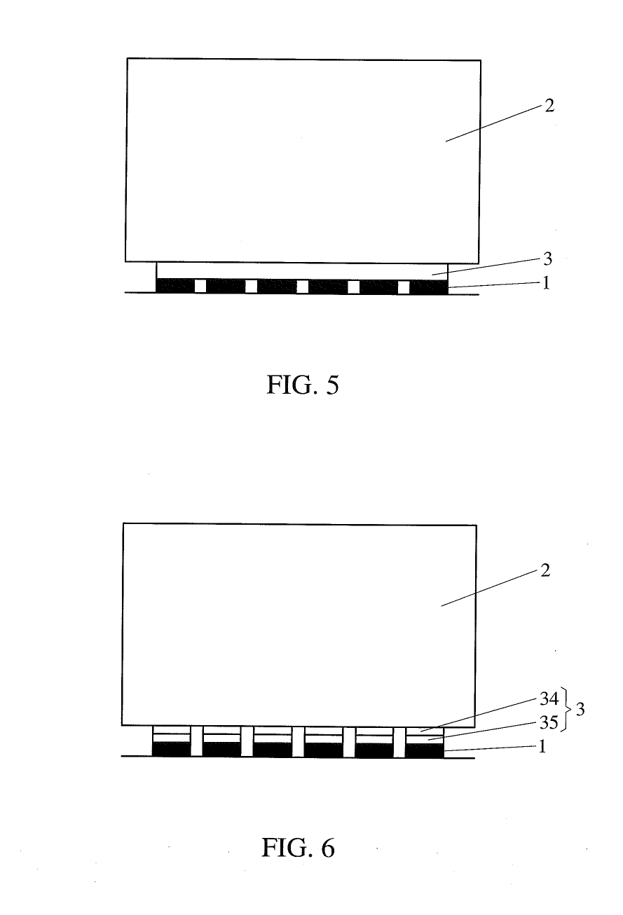

FIG. 5 is a schematic structural diagram of a backlight module according a second embodiment of the invention. As shown in FIG. 5, in the second embodiment, the backlight module includes a single light-transmitting structure 3. The light-transmitting structure 3 corresponds to the light incident surface 21 of the light guide plate 2; that is, the light-transmitting structure 3 is disposed on the whole light incident surface 21 of the light guide plate 2.

FIG. 6 is a schematic structural diagram of a backlight module according a third embodiment of the invention. As shown in FIG. 6, in the third embodiment, the backlight module includes light-transmitting structures 3, and the light-transmitting structures 3 correspond to the light exit surfaces 11 of the light source 1, respectively. Each of the light-transmitting structures 3 consists of two sheet-like structures 34 and 35, and the sheet-like structures 34 and 35 are made of transparent material. The embodiment is not used to limit the invention; for example, the light-transmitting structure may consist of a single sheet-like structure or more than one sheet-like structure.

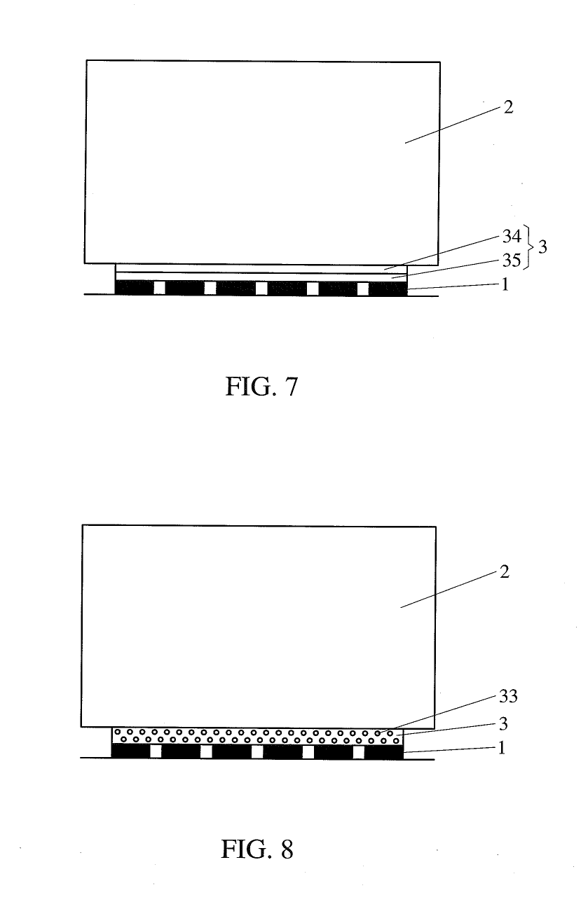

FIG. 7 is a schematic structural diagram of a backlight module according a fourth embodiment of the invention. As shown in FIG. 7, in the fourth embodiment, the backlight module includes a single light-transmitting structure 3, and the light-transmitting structure 3 corresponds to the light incident surface 21 of the light guide plate 2. The light-transmitting structure 3 consists of two sheet-like structures 34 and 35, and the sheet-like structures 34 and 35 are made of transparent material. The embodiment is not used to limit the invention; for example, the light-transmitting structure may consist of a single sheet-like structure or more than one sheet-like structure.

FIG. 8 is a schematic structural diagram of a backlight module according a fifth embodiment of the invention. As shown in FIG. 8, in the fifth embodiment, the light-transmitting structure 3 may be doped with a material 33. The material 33 may be diffuser particles or bubbles used to make light distribution more uniform. The diffuser particles may have a mean diameter between 0.1 μm and 100 μm. The diffuser particles may be made of Al₂O₃, B₂O₃, BaCO₃, Bi₂O₃, CaCO₃, CeO₂, Cr₂O₃, COO, Co₃O₄, CuO, Dy₂O₃, Er₂O₃, Eu₂O₃, Fe₂O₃, Ga₂O₃, Ge₂O₃, Gd₂O₃, HfO₂, Ho₂O₃, In₂O₃, K₂O₃, Li₂CO₃, M_{g}O, Mn₂O₃, Nb₂O₅, Nd₂O₃, NiO, PbO, SiO₂, Sm₂O₃, SnO₂, Ta₂O₅, Tb₄O₇, TiO₂, WO₃, Y₂O₃, ZnO, or ZrO₂.

In addition, the material 33 may be phosphor powders used to make light emitted by the light source 1 have variable color according to the kind of the phosphor powders when passing through the light-transmitting structure 3.

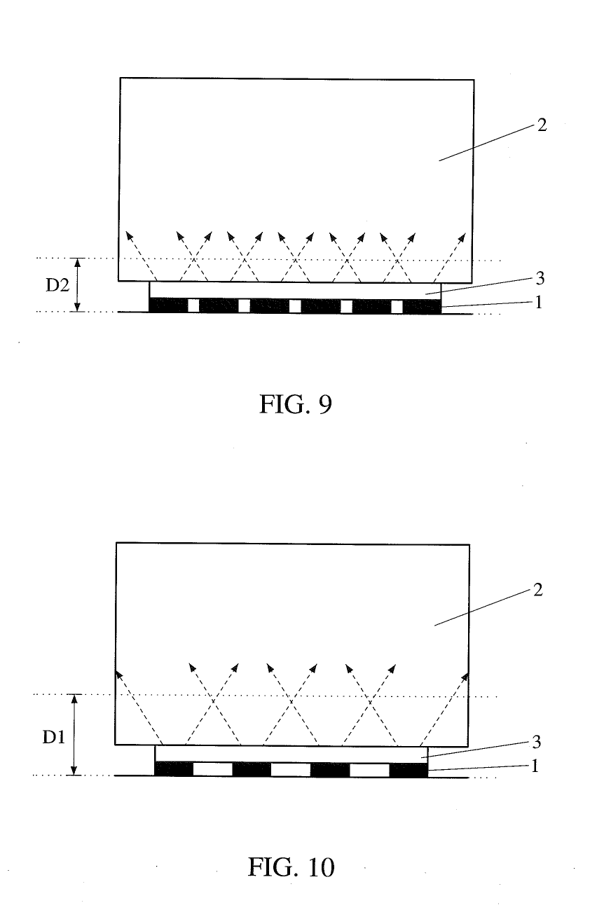

FIG. 9 is a schematic light-mixing diagram of a backlight module according an embodiment of the invention using the same number of LEDs, compared to the conventional backlight module as shown in FIG. 2. As shown in FIG. 9, under the condition of the same number of LEDs of the light source 1, the backlight module according the embodiment of the invention may achieve uniform light mixing in a distance D2 which is shorter than the distance D1 as shown in FIG. 2; therefore, the bezel required to contain the backlight module may be narrower so as to meet the need for the narrow bezel design of modern displays.

FIG. 10 is a schematic light-mixing diagram of a backlight module according an embodiment of the invention having the same light-mixing distance, compared to the conventional backlight module as shown in FIG. 2. As shown in FIG. 10, under the condition of the same light-mixing distance D1, the backlight module according the embodiment of the invention may use the reduced number of LEDs of the light source 1.

In an embodiment, the light-transmitting structure may be made of PETG, PP, PTFE, PVC, PS, PET, PMMA, PC, PA, PI, silicone, etc. The light-transmitting structure may be an elastic structure or a viscous structure. When the light-transmitting structure is an elastic structure or a viscous structure, the light-transmitting structure may be made of resin, acrylic, silicone, etc.

In an embodiment, the light-transmitting structure may have a refractive index between 1.0 and 2.0. Preferably, the refractive index of the light-transmitting structure is between 1.4 and 1.6. More preferably, the light-transmitting structure may have a refractive index the same as that of the light guide plate. The light-transmitting structure may be in a liquid state, a gel state, or a solid state.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

I claim:

1. A backlight module comprising:
a light source comprising a plurality of LEDs, each of the LEDs having a light exit surface;
a light guide plate made of transparent material, the light guide plate having a light incident surface and a light exit surface perpendicular to the light incident surface; and,
a light-transmitting structure made of transparent material, the light-transmitting structure having a light incident surface and a light exit surface opposite to the light incident surface, the light-transmitting structure being disposed between the light exit surfaces of the light source and the light incident surface of the light guide plate, and filling a gap between the light exit surfaces of the light source and the light incident surface of the light guide plate;
wherein the light exit surfaces of the light source are connected to the light incident surface of the light-transmitting structure; the light exit surface of the light-transmitting structure is connected to the light incident surface of the light guide plate; light emitted by the light source is diffused by the light guide plate to output through the light exit surface of the light guide plate.

2. The backlight module as claimed in claim 1, wherein the light-transmitting structure has a refractive index between 1.0 and 2.0.

3. The backlight module as claimed in claim 2, wherein the refractive index of the light-transmitting structure is between 1.4 and 1.6.

4. The backlight module as claimed in claim 1, wherein the light-transmitting structure has a refractive index the same as that of the light guide plate.

5. The backlight module as claimed in claim 1, wherein the light-transmitting structure is an elastic structure or a viscous structure.

6. The backlight module as claimed in claim 5, wherein the light-transmitting structure is made of resin, acrylic, or silicone.

7. The backlight module as claimed in claim 1, wherein the light-transmitting structure consists of at least one sheet-like structure made of transparent material.

8. The backlight module as claimed in claim 1, wherein the light-transmitting structure is doped with diffuser particles, bubbles, or phosphor powders.

9. The backlight module as claimed in claim 8, wherein the diffuser particles are made of Al₂O₃, B₂O₃, BaCO₃, Bi₂O₃, CaCO₃, CeO₂, Cr₂O₃, CoO, Co₃O₄, CuO, Dy₂O₃, Er₂O₃, Eu₂O₃, Fe₂O₃, Ga₂O₃, Ge₂O₃, Gd₂O₃, HfO₂, Ho₂O₃, In₂O₃, K₂O₃, Li₂CO₃, MgO, Mn₂O₃, Nb₂O₅, Nd₂O₃, NiO, PbO, SiO₂, Sm₂O₃, SnO₂, Ta₂O₅, Tb₄O₇, TiO₂, WO₃, Y₂O₃, ZnO, or ZrO₂.

10. The backlight module as claimed in claim 8, wherein the diffuser particles have a mean diameter between 0.1 μm and 100 μm.

11. The backlight module as claimed in claim 10, wherein the diffuser particles are made of Al₂O₃, B₂O₃, BaCO₃, Bi₂O₃, CaCO₃, CeO₂, Cr₂O₃, CoO, Co₃O₄, CuO, Dy₂O₃, Er₂O₃, Eu₂O₃, Fe₂O₃, Ga₂O₃, Ge₂O₃, Gd₂O₃, HfO₂, Ho₂O₃, In₂O₃, K₂O₃, Li₂CO₃, MgO, Mn₂O₃, Nb₂O₅, Nd₂O₃, NiO, PbO, SiO₂, Sm₂O₃, SnO₂, Ta₂O₅, Tb₄O₇, TiO₂, WO₃, Y₂O₃, ZnO, or ZrO₂.

12. The backlight module as claimed in claim 1, wherein the light-transmitting structure is in a liquid state, a gel state, or a solid state.

13. The backlight module as claimed in claim 1, wherein the light-transmitting structure is made of PETG, PP, PTFE, PVC, PS, PET, PMMA, PC, PA, PI, or silicone.
